(19) United States
(12) Patent Application Publication
(10) Pub. No.: US 2007/0072025 A1
(43) Pub. Date: Mar. 29, 2007

(54) PORTABLE FUEL CELL APPARATUS

(76) Inventor: CHUN-CHIN TUNG, Chupei (TW)

Correspondence Address: G. LINK CO., LTD., 3550 BELL ROAD, MINOOKA, IL, 60447, US

(21) Appl. No.: 11/535,640

(22) Filed: Sep. 27, 2006

(30) Foreign Application Priority Data
Sep. 29, 2005 (TW) 094216791

(51) Int. Cl. H01M 8/04

(52) U.S. Cl. 429/23

(57) ABSTRACT

The present invention relates to a portable fuel cell apparatus, comprising: a fuel cell, an interface controller, a voltage regulating circuit and a memory unit, wherein the voltage regulating circuit comprises a circuit for converting the electric power into a steady voltage output, and the interface controller comprises a data communication transformation interface. The power is generated by the fuel cell and transmitted to the voltage regulating circuit to be converted into the steady voltage for being transmitted to the interface controller. The interface controller can perform the transmission and distribution of the electric power and the data access of the memory unit. In addition, according to the current output of the fuel cell, the power property thereof and the voltage demand of interface controller, the voltage regulating circuit converts the power from the fuel cell into the steady voltage to be transmitted to the interface controller 2 by means of buck logic and boost logic.

### FIELD OF THE INVENTION

The present invention relates to a portable fuel cell apparatus, and more particularly to an interface provided, through which the transmission and distribution of the electric power and the input and output of the electric signal are conducted.

### BACKGROUND OF THE INVENTION

A conventional fuel cell uses hydrogen-rich fuel, such as methanol, to form a current circuitry after an oxido-reduction reaction, so as to generate electric power. However, with the increase of mobile electronic products, the demand on the portable energy increases accordingly. If a fuel cell can be assembled into a portable electronic device, the fuel cell can not only supply electric power for the electronic devices, but also output electric power to supply other electronic devices through the electric transmission of the communication interface of the electronic device. In addition, on the practical application of the fuel cell, the change in loading affects the electrochemical reaction of the fuel cell, so that the electric power output is altered.

Therefore, in consideration of the deficiencies of the conventional fuel cell and the demands of a better fuel cell, the portable fuel cell of the present invention is invented.

### SUMMARY OF THE INVENTION

It is an object of the present invention to provide a portable fuel cell apparatus with one communication interface selected from USB, PCMIC, CF and SDIO, so as to provide the electric power output of a fuel cell and the input and output of the electric signals.

It is a further object of the present invention to provide a portable fuel cell apparatus with a voltage regulating circuit for converting the electric power from the fuel cell into a steady voltage output.

It is a further object of the present invention to provide a portable fuel cell apparatus with a memory unit, which can serve as a data storage device with power supply.

For achieving the objects of the present invention stated above, the portable fuel cell apparatus of the present invention comprises a fuel cell, an interface controller, a voltage regulating circuit and a memory unit, wherein the voltage regulating circuit comprises a circuit for converting the electric power into a steady voltage output, and the interface controller comprises a data communication transformation interface. The power is generated by the fuel cell and transmitted to the voltage regulating circuit to be converted into the steady voltage for being transmitted to the interface controller. The interface controller can perform the transmission and distribution of the electric power and the data access of the memory unit. In addition, according to the current output of the fuel cell, the power property thereof and the voltage demand of interface controller, the voltage regulating circuit converts the electric power from the fuel cell into the steady voltage output to be transmitted to the interface controller 2 by means of buck logic and boost logic.

Furthermore, the interface controller can provide the electric power of the fuel cell to be output or to be transmitted to a desired electronic component in the portable fuel cell apparatus.

### BRIEF DESCRIPTION OF THE DRAWINGS

The foregoing and other objects, features and advantages of the present 20 invention will be more clearly understood through the following descriptions with reference to the drawings, wherein:

FIG. 1 is a block diagram illustrating the configuration of the components included in the portable fuel cell apparatus in accordance with a preferred embodiment of the present invention;

FIG. 2 is the perspective view of the portable fuel cell apparatus in accordance with the preferred embodiment of the present invention; and

FIG. 3 is a block diagram illustrating the configuration of the components included in the portable fuel cell apparatus in accordance with a further preferred embodiment of the present invention.

### DETAILED DESCRIPTION OF THE INVENTION

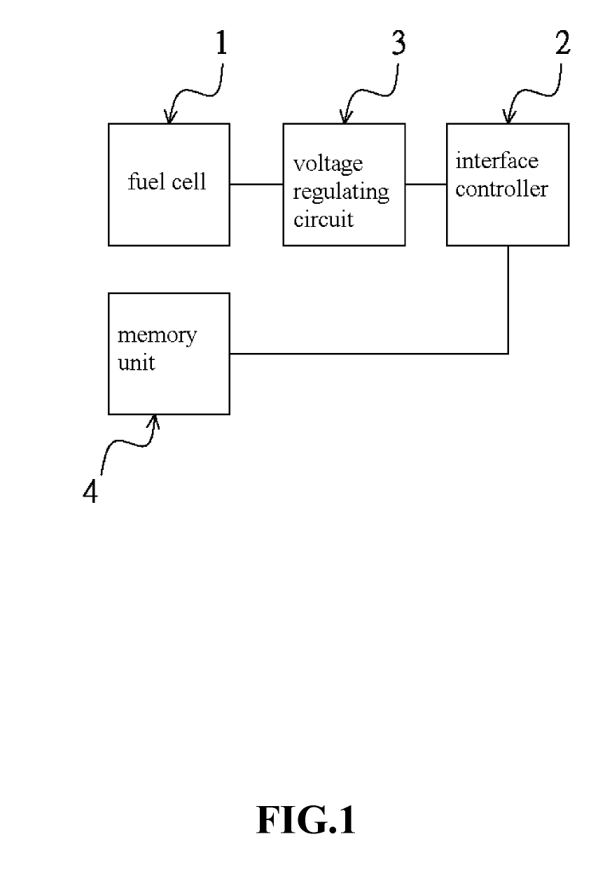

FIG. 1 is a diagram showing the configuration of the components included in the portable fuel cell apparatus in accordance with a preferred embodiment of the present invention. As shown in FIG. 1, the portable fuel cell apparatus of the present invention comprises a fuel cell 1, an interface controller 2, a voltage regulating circuit 3 and a memory unit 4. The fuel cell 1 is a kind of energy converter where an electrochemical reaction of the hydrogen-rich fuel, oxygen, and catalysts is induced therein, so as to generate the energy to be output therefrom. The interface controller 2 serves as a data communication transformation interface, which is one selected from USB, PCMIC, CF and SDIO for connecting the portable fuel cell apparatus to an electronic device, so that the transmission and exchange of the data communication is achieved thereby and the electric power could be output therefrom. The voltage regulating circuit 3 is a circuit for converting the electric power into a steady voltage output. The memory unit 4 relates to a circuit comprising a memory means, which is preferably composed of a semiconductor memory unit integrated with a circuit corresponding thereto, and the data therein is accessed through the interface controller 2.

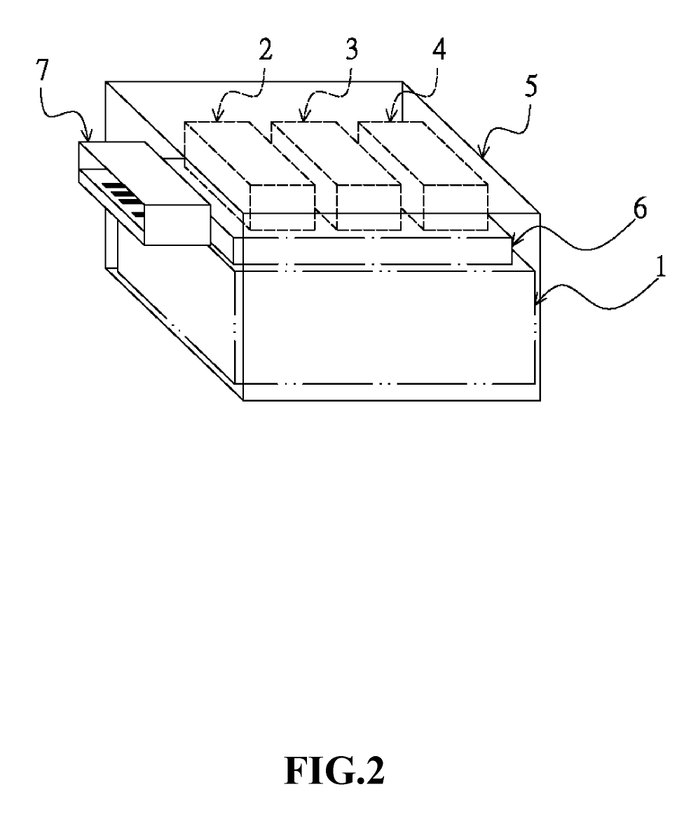

FIG. 2 shows a perspective view of the portable fuel cell apparatus in accordance with the preferred embodiment of the present invention. With reference to FIG. 2, the fuel cell 1, the voltage regulating circuit 3, the interface controller 2 and the memory unit 4 included in the mentioned portable fuel cell apparatus of the present invention are arranged in a case 5, where the voltage regulating circuit 3, the interface controller 2 and the memory unit 4 are disposed on a circuit board 6. The case 5 is provided with a connector 7 used for corresponding to the data communication transformation interface for the interface controller 2. Additionally, the fuel cell 1 comprises a basic structure of circuit board which can be further arranged on the circuit board 6, where the fuel supply, delivery and refill of the fuel cell 1 are known in the ordinary skill and not repeatedly described in detail herein.

In addition, the interface controller 2 and the memory unit 4 are serving as an audio-visual player or an audio-visual recorder such as MP3 player, MP4 player, and digital voice recorder, etc. Besides, the interface controller 2 can provide the electric power of the fuel cell 1 to be output or to be transmitted to the mentioned electronic device.

Depending on the current output of the fuel cell 1, the power property thereof and the voltage demand of interface controller 2, the voltage regulating circuit 3 of the portable fuel cell apparatus of the present invention may convert the power from the fuel cell 1 into a steady voltage output to be transmitted to the interface controller 2 by means of buck logic and boost logic. The interface controller 2, then, can provide the electric power with a steady voltage to be output therefrom or to be transmitted to a desired electronic component included in the mentioned electronic device.

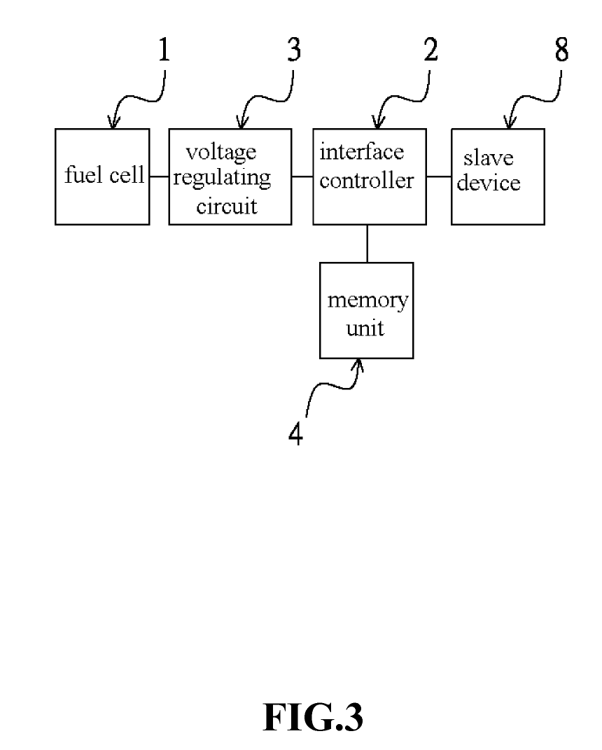

FIG. 3 is a diagram showing the configuration of the components included in the portable fuel cell apparatus in accordance with a further preferred embodiment of the present invention, in which the application of the portable fuel cell apparatus is demonstrated. In this embodiment, the USB OTG (on the go) is selected as the interface controller 2. The power produced from the fuel cell 1 is converted into a steady voltage through the voltage regulating circuit 3 and is then transmitted to the interface controller 2 whose USB OTG interface connector is electrically connected to a slave unit 8. The slave unit 8 is preferably a powerless portable disk or an electronic device with USB interface that is provided with a power supply or a rechargeable electronic component. In this case, the interface controller 2 can perform the data transmission and exchange between the memory unit 4 and the slave unit 8, or output the electric power or supply the electric power to the slave unit 8 thereby for operation and power storage therein.

In addition, the power output from the interface controller 2 and the data transmission thereof are achieved through the circuit of USB interface.

The above statements are used to explain the preferred embodiment of the present invention, but not to put any restriction on the invention. Therefore, any modification or variation made for the same purpose would still be in the scope of the present invention.

What is claimed is:

1. A portable fuel cell apparatus, comprising:
a fuel cell;
an interface controller serving as an interface for transforming data communication and for transmitting electric power; a voltage regulating circuit comprising a circuit for converting the electric power into a steady voltage output; and
a memory unit,
wherein the power is generated by the fuel cell and transmitted to the voltage regulating circuit to be converted into the steady voltage for being transmitted to the interface controller, and wherein the transmission and distribution of the electric power and the data access of the memory unit can be performed by the interface controller.

2. The portable fuel cell apparatus of claim 1, wherein the fuel cell, the voltage regulating circuit, the interface controller and the memory unit are configured in a case, which is provided with a connector of an interface connector structure corresponding to the data communication transformation interface for the interface controller.

3. The portable fuel cell apparatus of claim 2, wherein the voltage regulating circuit, the interface controller and the memory unit are disposed on a circuit board.

4. The portable fuel cell apparatus of claim 3, wherein the fuel cell is further configured on the circuit board.

5. The portable fuel cell apparatus of claim 1, wherein the interface controller is one selected from a communicating interface of USB, PCMIC, CF and SDIO.

6. The portable fuel cell apparatus of claim 1, wherein the voltage regulating circuit converts the power from the fuel cell into the steady voltage to be output to the interface controller 2 by means of buck logic and boost logic, depending on the current output of the fuel cell, the power property thereof and the voltage demand of interface controller.

7. The portable fuel cell apparatus of claim 1, wherein the memory unit is composed of a semiconductor memory component integrated with a circuit corresponding thereto.

8. The portable fuel cell apparatus of claim 1, wherein the interface controller and the memory unit form an audio-visual player or recorder.

9. The portable fuel cell apparatus of claim 7, wherein the interface controller and the memory unit form an electronic device selected from a group consisting of a MP3 player, a MP4 player and a digital recorder.

10. The portable fuel cell apparatus of claim 1, wherein the power from the fuel cell can be output and be supplied to a desired electronic component included therein through the interface controller.
